(19) United States
(12) Patent Application Publication
(10) Pub. No.: US 2025/0039242 A1
(43) Pub. Date: Jan. 30, 2025

(54) Kill-chain reconstruction

(71) Applicant: Zscaler, Inc., San Jose, CA (US)

(72) Inventors: Deepen Desai, San Ramon, CA (US); Zicun Cong, Burnaby (CA); Akshay Paliwal, Bangalore (IN); Aakarshan Chauhan, Bangalore (IN); Janmey Sandeep Shukla, Bangalore (IN); Shubham Khandhar, Burnaby (CA); Rex Shang, Los Altos, CA (US)

(73) Assignee: Zscaler, Inc., San Jose, CA (US)

(21) Appl. No.: 18/910,792

(22) Filed: Oct. 9, 2024

Related U.S. Application Data
(63) Continuation-in-part of application No. 18/358,481, filed on Jul. 25, 2023.

(30) Foreign Application Priority Data
Nov. 23, 2021 (IN) 202111053875

(51) Int. Cl. H04L 9/40

(52) U.S. Cl. CPC H04L 63/20

(57) ABSTRACT

Kill-chain reconstruction via machine learning includes, responsive to (1) training one or more machine learning models for kill-chain reconstruction, (2) monitoring one or more users associated with an enterprise, and (3) detecting an incident that is one or more of a threat and a policy violation for a user of the one or more users, identifying a transaction associated with the threat and a policy violation as a seed transaction; retrieving transactions of the user from a preconfigured time window leading up to and occurring after the seed transaction; and reconstructing a kill-chain based on the seed transaction and the time window.

### CROSS-REFERENCE TO RELATED APPLICATION(S)

The present disclosure is a continuation-in-part of U.S. patent application Ser. No. 18/358,481, filed Jul. 25, 2023, and entitled “Breach prediction via machine learning,” the contents of which are incorporated by reference in their entirety.

### FIELD OF THE DISCLOSURE

The present disclosure relates generally to networking and computing. More particularly, the present disclosure relates to systems and methods for kill-chain reconstruction.

### BACKGROUND OF THE DISCLOSURE

Cyberthreats are evolving and becoming advanced as well as critically impacting business. Also, the modern workforce has resulted in an increase in users, devices, and applications existing outside of controlled networks, including corporate networks. As a result, the business emphasis on the “network” has decreased and the reliance on the internet as the connective tissue for businesses has increased. Even further, the workforce has shifted from the office to work from home, accordingly, attack surfaces have grown concurrently with a dispersed workforce. Coupled with increased reliance on public cloud services and vulnerable enterprise virtual private networks (VPNs), large organizations not using zero trust security became more vulnerable to network intrusion attacks. “Exposed” identifies the most common attack surface trends by geography and company size while spotlighting the industry's most vulnerable to public cloud exposure, malware, ransomware, and data breaches.

As described herein, a breach is anytime someone gains unauthorized access to an entity's (i.e., enterprise, organization, etc.) system, network, or resources. A breach can lead to significant harm, namely malware, data loss, data theft, lost productivity, reputational harm, and the like. Importantly, breaches are common and often unreported.

### BRIEF SUMMARY OF THE DISCLOSURE

The present disclosure relates to systems and methods for kill-chain reconstruction. This is based on leveraging a cloud service's vast amount of data used in providing various cloud-based security services, such as endpoint security, Internet access, private application access, posture control, threat intelligence, etc. For example, Zscaler, the applicant of the present application, monitors inline transactions exceeding over 300B per day from tens of thousands of organizations and having over 8B blocked transactions daily for policy violations and blocked threats. The present disclosure contemplates using this historical data for training a machine learning model that can then be used in production to predict kill-chains based on user transactions.

Various embodiments of the present systems and methods include responsive to (1) training one or more machine learning models for kill-chain reconstruction, (2) monitoring one or more users associated with an enterprise, and (3) detecting an incident that is one or more of a threat and a policy violation for a user of the one or more users, identifying a transaction associated with the threat and a policy violation as a seed transaction; retrieving transactions of the user from a preconfigured time window leading up to the seed transaction; and reconstructing a kill-chain based on the seed transaction and the time window.

The steps can further include wherein the reconstruction is performed by the one or more machine learning models. The kill-chain can include one or more malicious events which might follow the seed transaction. The kill-chain can include one or more transactions that occurred within the time window that are correlated to the seed transaction. A transaction can be correlated to the seed transaction based on a particular website associated with the transaction statistically occurring together with a domain associated with the seed transaction. A transaction can be correlated to the seed transaction based on one or more features of the transaction. The one or more features of the transaction can include any of Uniform Resource Locator (URL) features, Request & Response (R&R) features, User Agent (UA) features, Message Digest 5 (MD5) features, policy features, and context features. The reconstructing can be performed using a graph-based approach. Each transaction in the kill-chain can be assigned a corresponding MITRE attack stage. The transactions of the user from the preconfigured time window can be obtained from a cloud-based system that performs monitoring of the one or more users.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a block diagram of a breach prediction system which includes an artificial intelligence breach prediction and policy recommendation engine.

FIGS. 5-10 are screenshots of an example of a breach prediction large language model (LLM).

FIG. 11 is a flowchart of a breach prediction process utilizing the cloud-based system, associated data, and the breach prediction system.

FIG. 12 is an example of a log.

FIG. 13 is an example of a kill-chain.

FIG. 14 is a flowchart of a kill-chain reconstruction process.

### DETAILED DESCRIPTION OF THE DISCLOSURE

### § 1.0 Cybersecurity Monitoring and Protection Examples

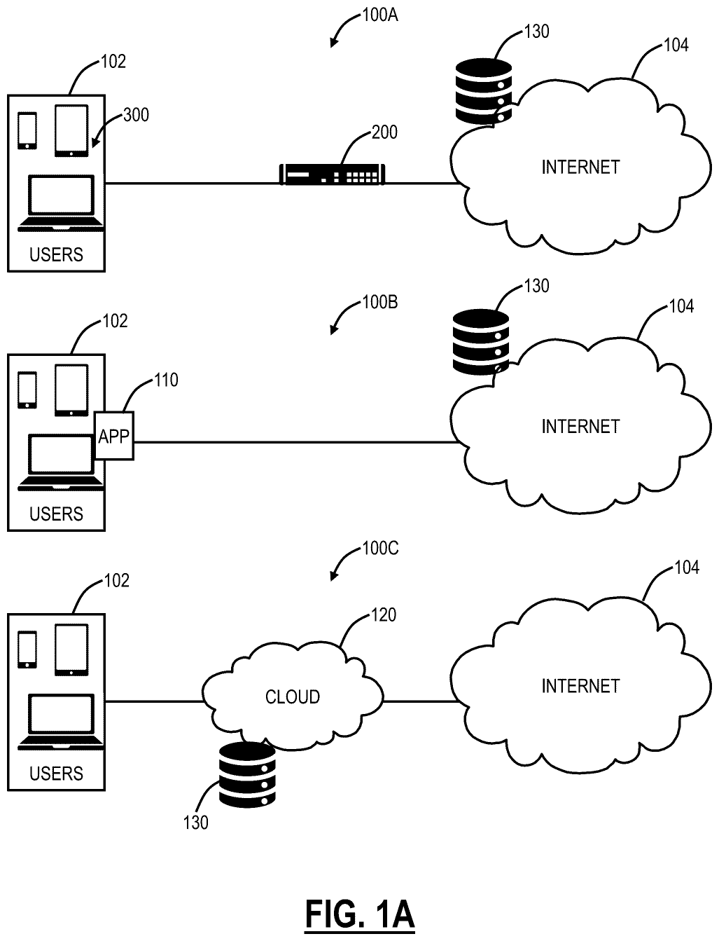

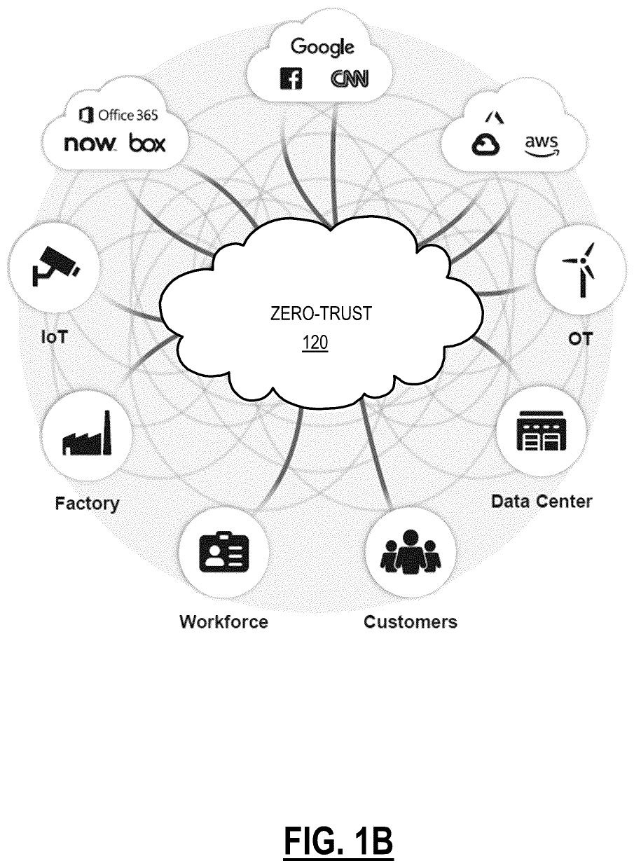

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

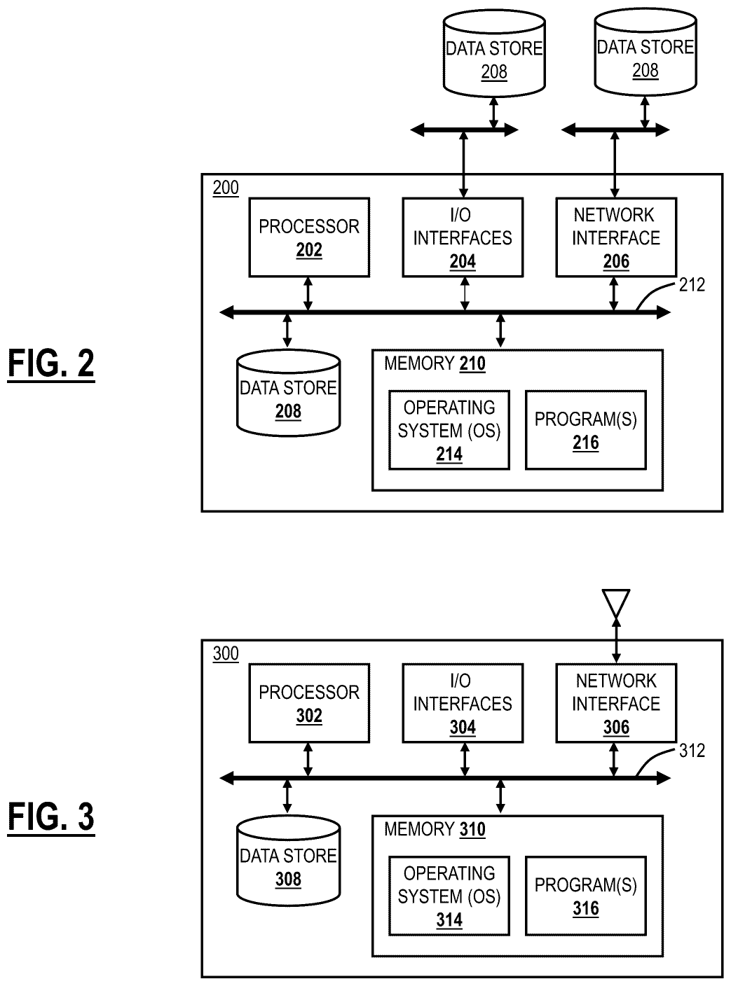

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QOS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time-before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Pat. No. 8,429,111, issued Apr. 23, 2013, and entitled “Encoding and compression of statistical data,” the contents of which are incorporated herein by reference, describes compression techniques for storing such logs,

Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### Breach Prediction

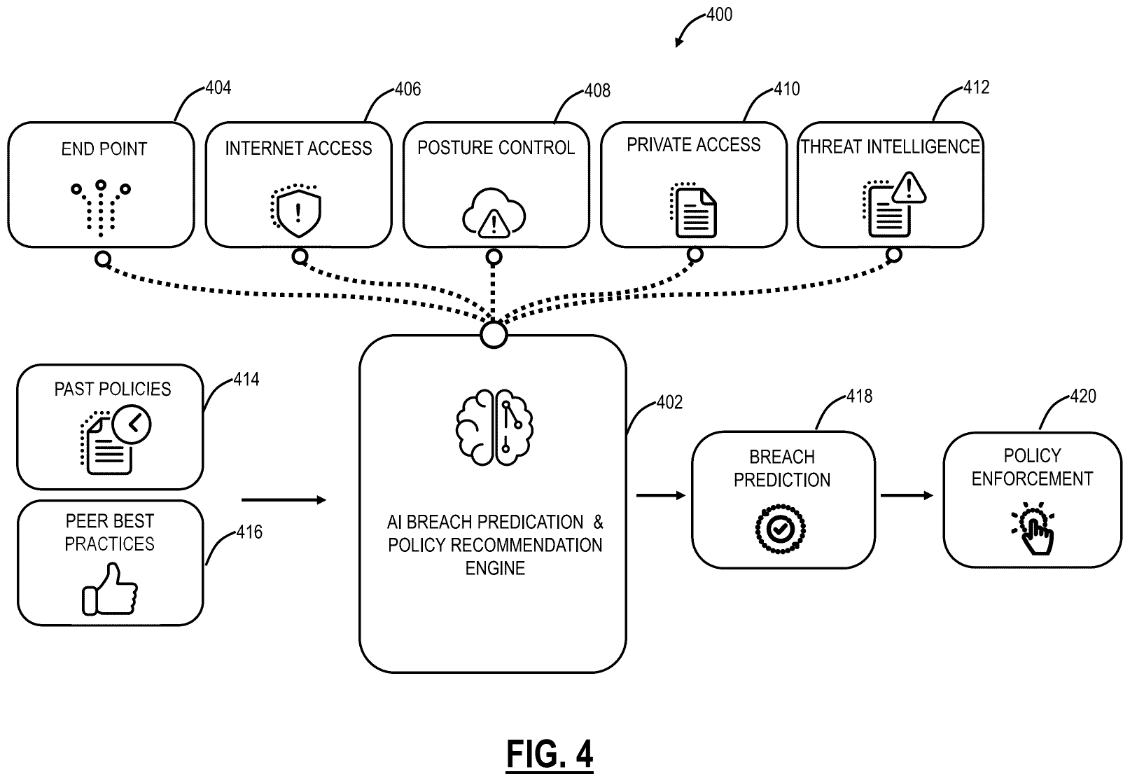

FIG. 4 is a block diagram of a breach prediction system 400 which includes an artificial intelligence breach prediction and policy recommendation engine 402. The engine 402 can be realized as software executed via one or more processors, via the cloud-based system 120, via one or more of the servers 200, and the like. The engine 402 includes one or more machine learning models that are trained based on various data 404-412, including endpoint data 404, Internet access data 406, posture control data 408, private application access data 410, and threat intelligence data 412. We are using the cloud-based system's 120 visibility across endpoint, network (both internal & external), public cloud, and enriching that with our world class the threat intelligence data 412 to train the AI breach prediction and policy recommendation engine 402. Our goal here is to harness the power of generative AI in combination with multi-dimensional models for the engine 402 to predict potential breach scenarios.

The engine 402 can also be trained with past policies 414 with the data 404-412. Further, we also recommend policies based on the activity observed to prevent the breach. Specifically, the engine 402 can be trained with best practices 416 for recommendations with any predictions. Once trained, the engine 402 can monitor log data from the cloud-based system 120 or from databases to provide a real-time indication of a breach prediction 418 along with policy enforcement recommendations 420.

The cloud-based system 120 provides visibility across the kill-chain with full context of users 102 and assets in the organization. Again, the cloud-based system 120 has a significant cloud security data lake with the ability to correlate events across thousands of organizations.

### Example of Breach Prediction

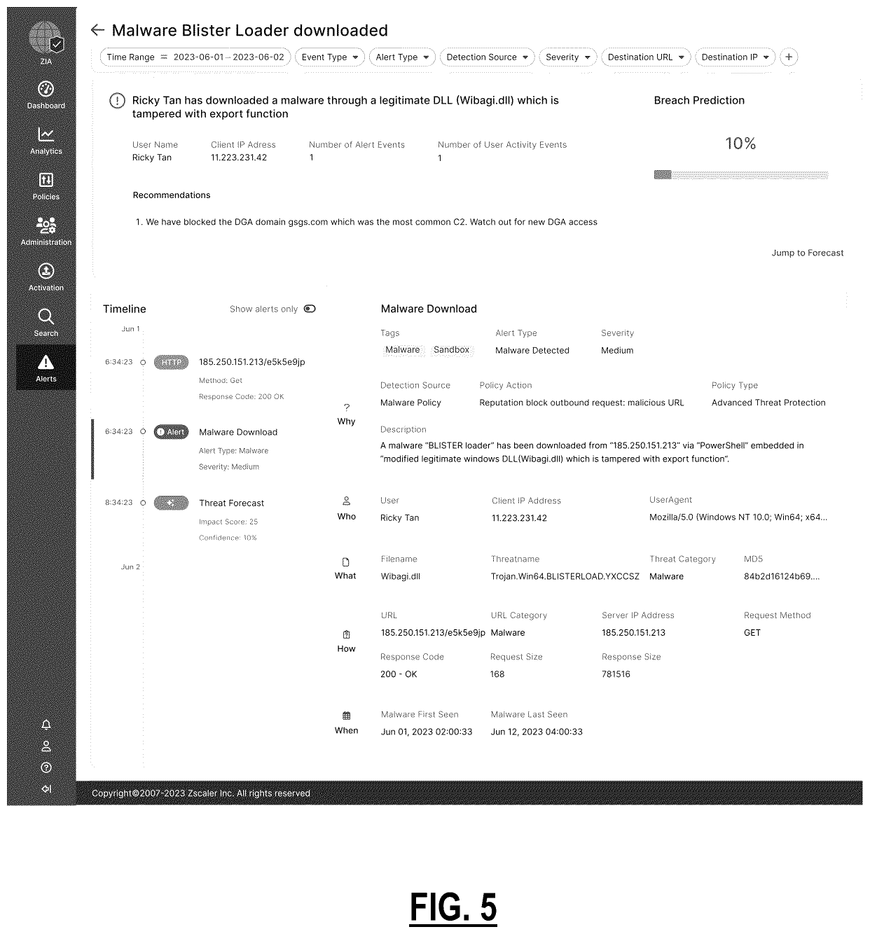

FIGS. 5-10 are screenshots of an example of a breach prediction large language model (LLM). Let's walk you through an example to show Breach Prediction LLM in action: In particular, this example assumes the engine 402 has been trained based with the various data in FIG. 4. The engine 402 is being used in the cloud-based system 120, such as via a management system, a SIEM system, a storage cluster, and the like. For example, the screenshots can be part of the management system. In particular, this example walks through various steps in the kill-chain, illustrating enhancements made by the engine 402 through the process.

In FIG. 5, a user, Ricky Tan, belonging to an organization, downloads pirated software (happens all the time) that results in a malware infection. By itself, this is not a big deal, it is an incident that should be responded, and mitigated but it is not a fire. Here, at this stage, the engine 402 has analyzed all of the data and predicts only a 10% breach prediction. Note, the user interface in FIG. 5 provides various details about the incident, recommendation (blocking the domain, etc.), a timeline, and the breach prediction value is provided as an enhancement.

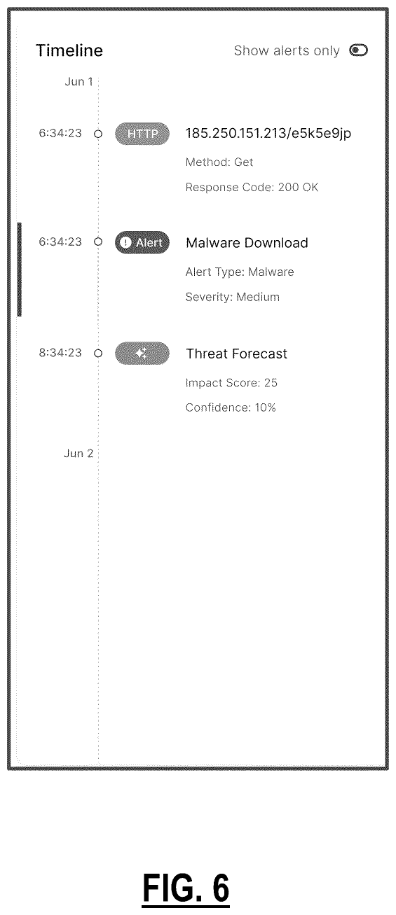

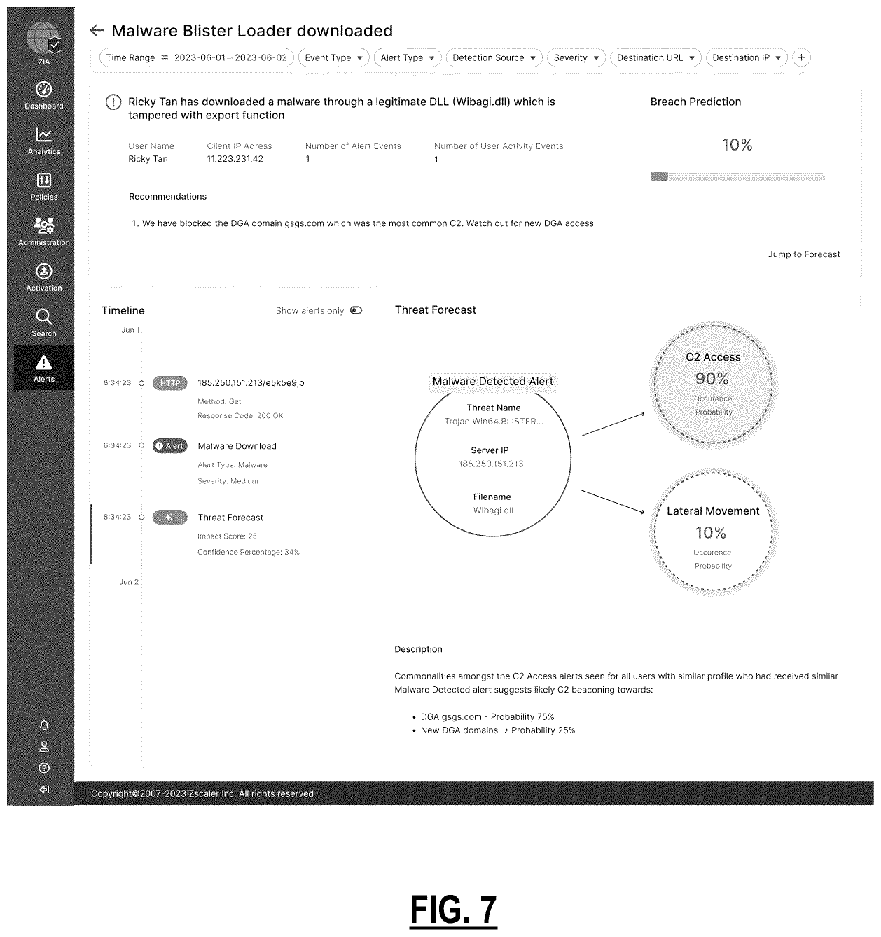

FIG. 6 expands the timeline from FIG. 5. This shows visually the chain of events that led to the malware infection. FIG. 7 includes a threat forecast in addition to the breach prediction. This is derived from the engine 402. In this example, the detected malware in FIG. 5 has a large probability of being command-and-control (C2) (90%) versus lateral movement (10%). It has high probability of performing C2 activity which if successful can lead to lateral propagation. Let's assume that no action was taken at this stage.

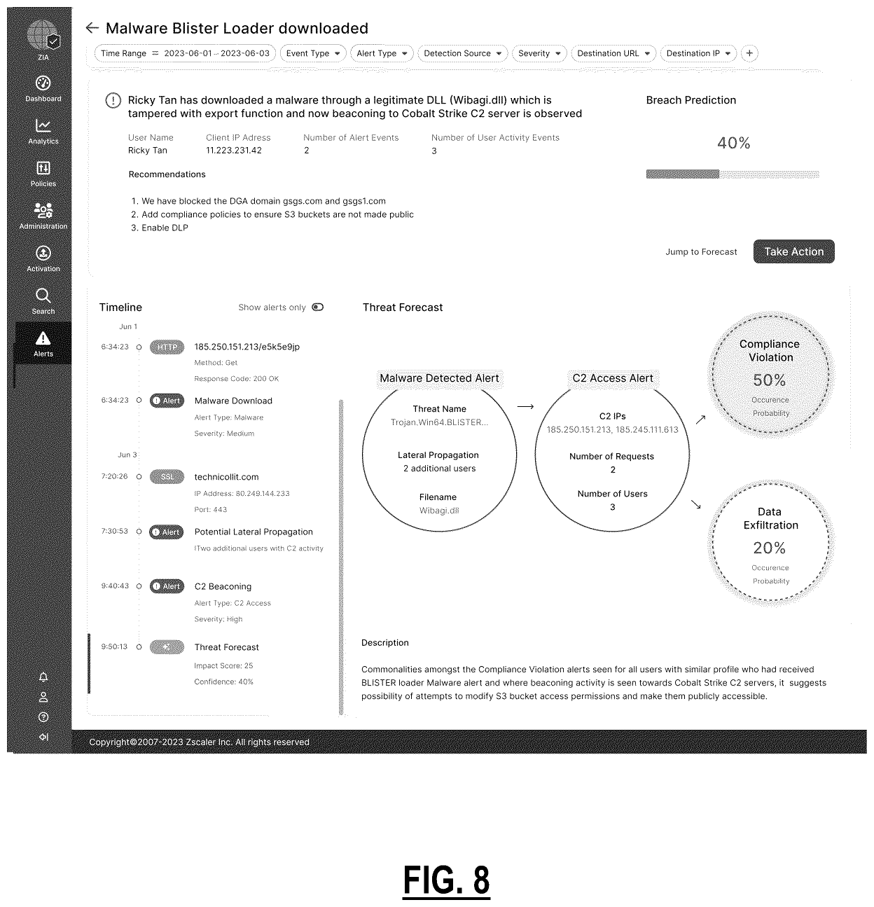

FIG. 8 shows after some time (see the timeline), there are now two additional users 102 experiencing C2 activity which is indicative of potential lateral propagation followed by persistent C2 activity. The threat forecast is updated showing lateral propagation to two additional users and a total of three users showing persistent C2 activity. Based on the previous learnings from similar activity seen across other organizations in the cloud-based system 120, probability of potential compliance violation and data exfiltration starts going up, i.e., the breach prediction is now at 40%. With the breach prediction indicator at 40%. You have an option to take action at this stage and mitigate this before it progresses further, e.g., adding compliance policies, enabling DLP, etc., but let's assume no action is taken.

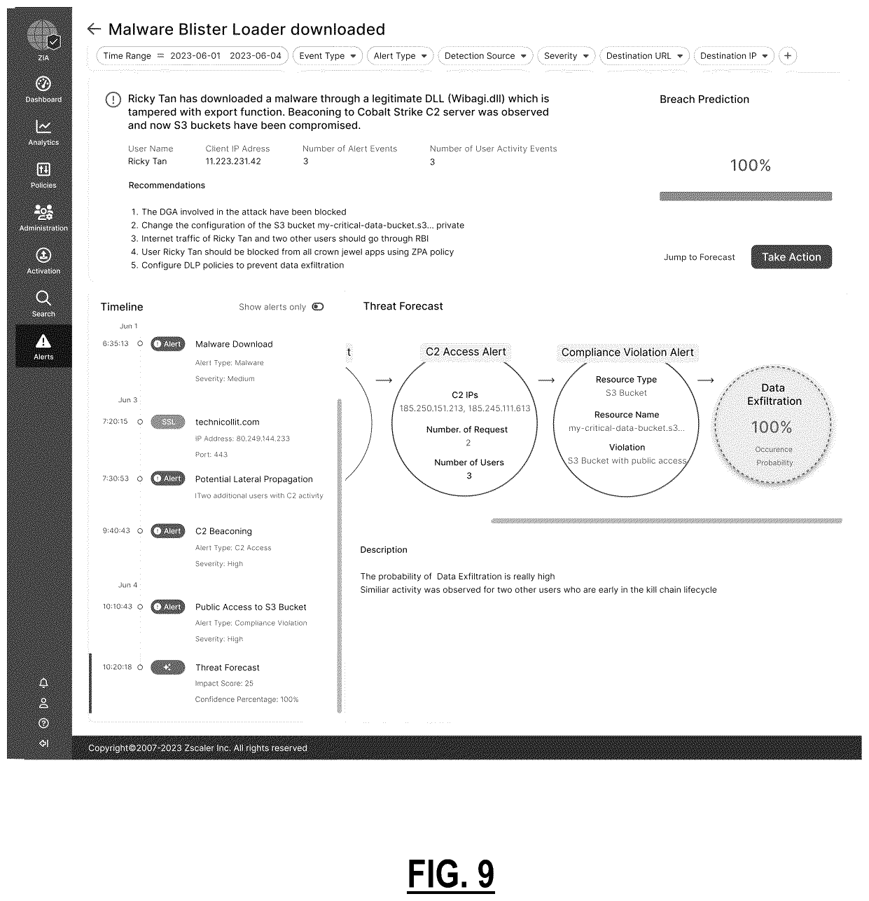

FIG. 9 shows activity after additional time. Next, we see a critical compliance violation from one of the infected users resulting in an exposed S3 bucket. This is indicative of hands-on keyboard activity where the threat actor changed the permission of a S3 bucket with the intent of exfiltrating data. We now have three different users with persistent C2 activity and a critical compliance violation from one of the user that could result in potential data exfiltration. If the organization fails to take action at this stage, then there will be more lateral propagation activity and data from crown-jewel applications exfiltrated using the open S3 bucket with a high probability of ransomware payload being downloaded. This will push our breach prediction indicator to 100%.

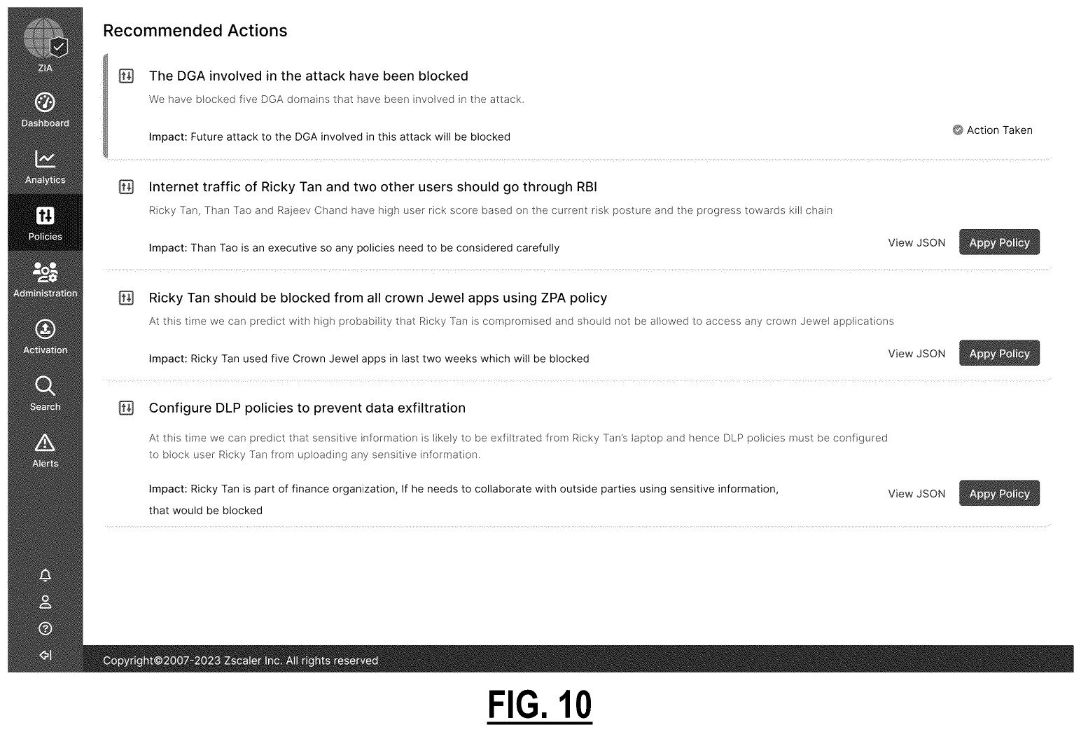

FIG. 10 shows policy recommendations based on the activity observed, to prevent the breach. In this case, we see recommendations of redirecting the three impacted users through browser isolation as well as blocking their access to crown-jewel applications to prevent potential data exfil. This can be extended with customized LLM to predict breaches and securely enforce policies to prevent the breach based on the activity observed. And you are still in control-all you have to do is enter a form of multifactor authentication (MFA) to authorize these policy changes.

### Breach Prediction Process

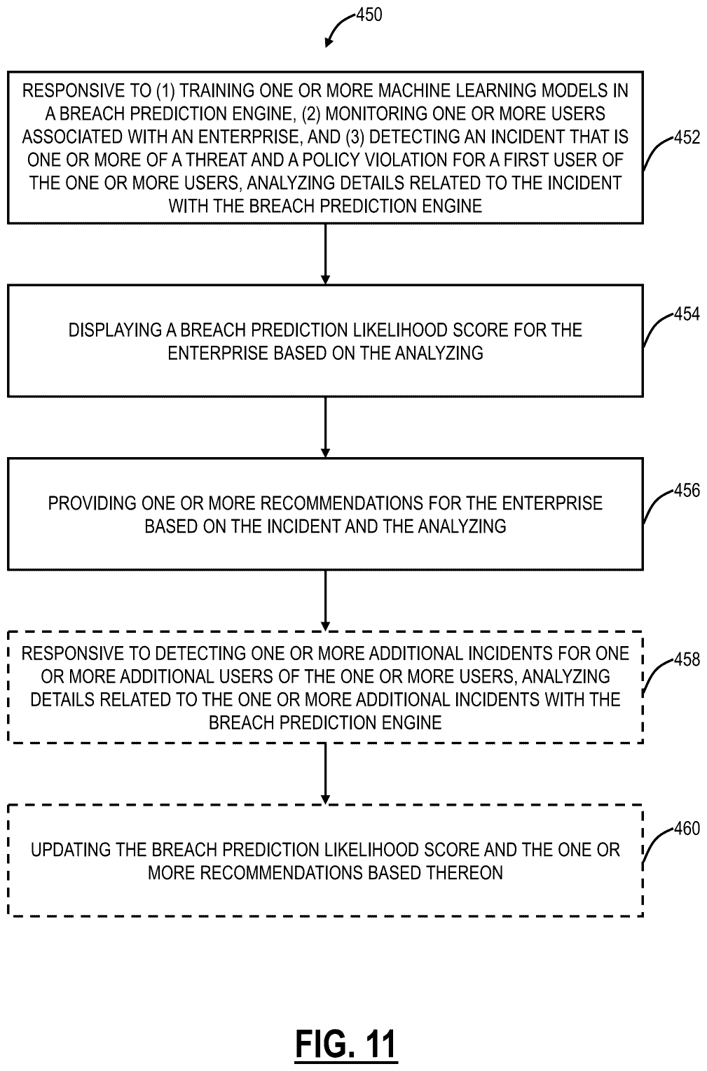

FIG. 11 is a flowchart of a breach prediction process 450 utilizing the cloud-based system 120, associated data, and the breach prediction system 400. The breach prediction process 450 can be a computer-implemented method having steps, implemented via one or more servers having processors configured to implement the steps, via the cloud-based system 120, and as instructions embodied in a non-transitory computer-readable medium for causing one or processors to implement the steps.

The breach prediction process 450 includes responsive to (1) training one or more machine learning models in a breach prediction engine, (2) monitoring one or more users associated with an enterprise, and (3) detecting an incident that is one or more of a threat and a policy violation for a first user of the one or more users, analyzing details related to the incident with the breach prediction engine (step 452); displaying a breach prediction likelihood score for the enterprise based on the analyzing (step 454); and providing one or more recommendations for the enterprise based on the incident and the analyzing (step 456). Again, see FIGS. 5-10 for an example.

The breach prediction process 450 can further include displaying the breach prediction likelihood score with associated details of the incident. The associated details include one or more of a threat forecast that visually displays probability of future activity related to the incident and a timeline of a chain of events associated with the incident.

The breach prediction process 450 can further include, responsive to detecting one or more additional incidents for one or more additional users of the one or more users, analyzing details related to the one or more additional incidents with the breach prediction engine (step 458); and updating the breach prediction likelihood score and the one or more recommendations based thereon (step 460). Of note, the breach prediction likelihood score can be continuously updated, graphed, etc. over time as events unfold.

The breach prediction process 450 can further include displaying the breach prediction likelihood score with associated details of the incident and the one or more additional incidents. The associated details include one or more of a threat forecast that visually displays probability of future activity related to the incident and the one or more additional incidents, and a timeline of a chain of events associated with the incident and the one or more additional incidents.

The one or more machine learning models can be trained with data from a cloud-based system that monitors a plurality of users from a plurality of enterprises. The data can include a plurality of endpoint data, Internet access data, posture control data, private application access data, and threat intelligence data.

The breach prediction process 450 can further include receiving input related to the one or more recommendations; and automatically causing remediation based on the input.

The breach prediction process 450 receiving feedback related to the incident from a user associated with the enterprise; and updating the training of the one or more machine learning models based on the feedback. Of note, the cloud-based system 120 can continually monitor, detect threats, etc. and this ongoing data along with user feedback can be used to further refine the machine learning models for accuracy. For example, a 100% breach prediction score did not result in a breach-update accordingly.

### Kill-Chain Reconstruction

The present disclosure further provides systems and methods for predicting and determining steps taken prior to and after a malicious transaction occurring in a network based on logs. The malicious action can include the utilization of malware of any kind. Based thereon, the present systems aim to predict and determine how a user ended up performing a particular transaction, ended up on a particular site, etc. A particular set of steps (within transaction logs) can be referred to as a kill-chain as described herein.

For example, based on detecting a C2 attack that can pose a high severity threat, the present systems can predict and determine the whole chain of events (the kill-chain) which led up to the particular threat. In this example, responsive to a user of an enterprise visiting a malicious URL, the present systems can determine all the steps/transactions that occurred prior to and after the user arriving at that particular malicious URL.

A log entry in the log represents a record capturing a network request sent from a customer's device along with the corresponding response from the destination. Each entry encompasses multiple attributes that detail the status of both the network request and response. These attributes include, but are not limited to, timestamp, user ID, URL, request method, response code, etc. A log sequence is an ordered aggregation of these log entries, arranged chronologically. We denote a log sequence as:

$$S = < {L}_{1} , … , {L}_{m} >$$

Where Lⱼ is the j-th log entry in the sequence.

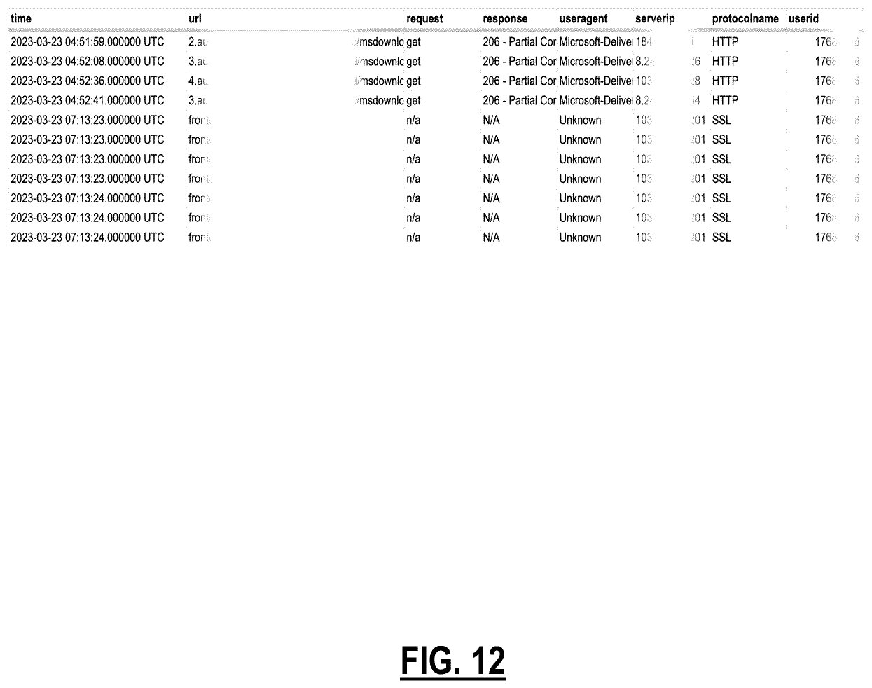

An example of a log is shown in FIG. 12 with PII data obfuscated. In the realm of network log analysis, an Indicator of Compromise (IoC) is typically identified as anomalous URLs that signal a system's compromised status. Further, The MITRE Adversarial Tactics, Techniques, and Common Knowledge (ATT&CK) framework is a widely acknowledged industry standard that describes various tactics and techniques employed in cyber-attacks. Within this framework, attack steps are categorized into stages such as Initial Access, Credential Access, Discovery, Lateral Movement, Command and Control, and Exfiltration.

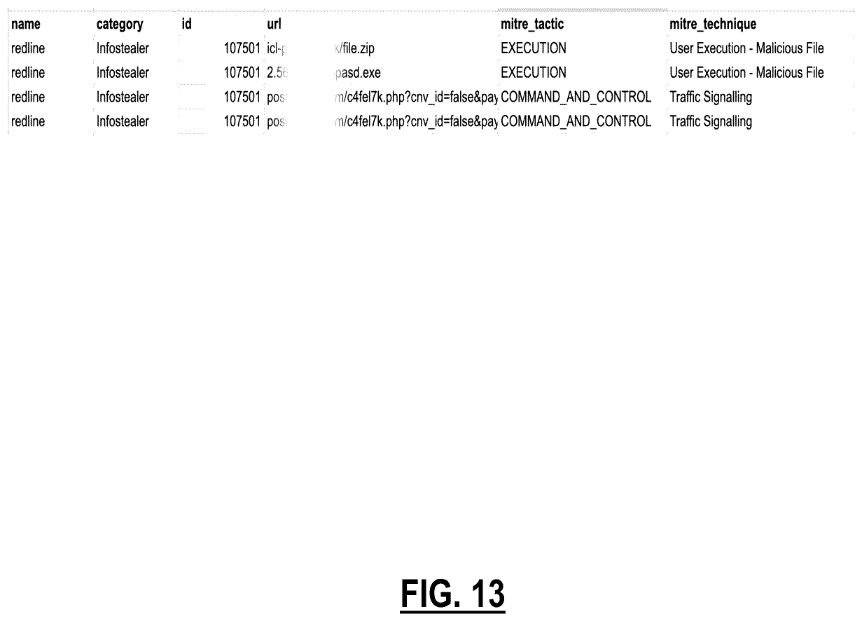

A cyber kill-chain can be conceptualized as a sequence of malicious activities that constitute a data breach attack. This sequence encompasses a series of IoCs, each associated with specific stages and techniques outlined in the MITRE ATT&CK framework. A kill-chain can be denoted as:

$$K = < ( {i}_{1} , {s}_{1} , {q}_{1} ) , … , ( {i}_{n} , {s}_{n} , {q}_{n} ) , M >$$

Where M is the threat family name, iⱼ the j-th IoC in the kill-chain, sⱼ and qⱼ represent the corresponding MITRE attack stage and technique, respectively. FIG. 13 is an example of a kill-chain including 4 IoCs.

The problem is a multi-class classification problem. In particular, the objective is to analyze a given log sequence S for potential cyber-attack activities. If the log sequence S includes elements indicative of a cyber-attack, the task involves extracting the corresponding kill-chain K, utilizing the URLs present in S. In particular, the output should be the threat family and a list of URLs along with their corresponding MITRE stages and MITRE techniques. In scenarios where the log sequence is devoid of any indicators of a cyber-attack, the output is classified as clean.

Reconstructing a kill-chain is a critical step in data breach prediction. A sequence of logs that includes at least one seed IoC. Given a suspicious log sequence, the primary goal is to determine the involvement of each log entry in the kill-chain. This involves two key predictions for each log entry including determining inclusion in the kill-chain and identifying the MITRE tactic. The first task is to assess whether a given log entry is a component of the kill-chain. For log entries identified as part of the kill-chain, the next step is to classify the corresponding MITRE tactic. In various embodiments, two separate models can be utilized to handle these tasks separately. Alternatively, one model can be used to perform the tasks in an end to end manner. Further, once the kill-chain is constructed, an additional analytical process is required to infer the threat family.

The likelihood of two kill-chains simultaneously existing within a 10-minute window in the log sequence is minimal, therefore, the present systems and methods focus on determining if a transaction is malicious based solely on its properties. That is, for attribution-based detection, any transaction identified as malicious can then be classified as part of a kill-chain.

Various embodiments of the present disclosure focus on breach prediction and kill-chain reconstruction. For breach prediction, the systems are adapted to, based on user activity and transactions, predict if the user will end up on a malicious site. As described herein, the systems can give a breach prediction score based on the steps taken by a user, the higher the score, the higher the possibility of the user ending up on a malicious site. Various embodiments include a UI saying that you have been exposed to one or more particular websites, and it might be possible that later on you might get in touch with a particular website which actually leads up to the user being compromised.

For kill-chain reconstruction, the process starts with a known malicious domain, or a suspicious domain detected by other ML models (seed transaction). That is, based on identifying an incident that is one or more of a threat and a policy violation for a user, the systems can associate the transaction as the seed transaction. Based thereon, the systems are adapted to identify and order one or more events that lead up to and occur after a user arriving at the malicious domain. This can be done by, upon detecting a user arriving at a malicious domain, retrieving transaction data of the user from a time period before and after the user arrived at that malicious domain. For example, the systems can utilize transaction data from a 10-minute time window including 5 minutes before the user arrived at the malicious domain and 5 minutes after the user arrived at the malicious domain. It will be appreciated that any other time window can be utilized for detecting kill-chain transactions. Based thereon, the systems can create a kill-chain based on the users' transactions. Transactions to various domains within the time window can be correlated to the malicious domain via relations between the various domains and the malicious domain. These relations can include, for example, sharing the same ASN. Further, the relations can be based on statistical relationships between the malicious domain and other domains in the transaction data. For example, a transaction may be correlated to the malicious domain based on it being observed that statistically, the particular website associated with the transaction occurs together with the malicious domain.

Once a plurality of relations and features are recognized within the transaction data, i.e., the transactions within the time window, between any of the malicious domain and the various intermediate transactions (transactions within the transaction data that occurred before the malicious domain was accessed), the systems can quantify the relations based on various features and determine which domains/transactions are part of the kill-chain that led to the malicious domain. Based on this, ML models can be trained to predict when certain transactions should be labeled as part of a kill-chain or not.

Again, the present disclosure provides systems and methods for identifying the likelihood that a transaction is a part of a kill-chain from a log of web traffic transactions. The log of web traffic transactions can be obtained from the cloud-based system 120 that performs monitoring of a plurality of users as described herein. A cyber kill-chain can be conceptualized as a sequence of malicious activities that constitute a data breach attack. Various embodiments utilize GraphML in combination with other ML models to detect the likelihood of a transaction being a part of a kill-chain (cyber kill-chain). Based thereon, kill-chains can be reconstructed via the various ML models.

The process can begin by generating a time window of 10 minutes around a known malicious domain which is called a seed, starting from the seed the systems try to generate all the chronologically ordered events which led the user to the seed and malicious events which might follow. In order to do this, the systems try to generate relations between all the observed hostnames within that time window. A ‘kill_chain_id’ or an ‘attack_chain_id’ is a unique identifier (hash value) for one such time window. One approach to detect kill-chain items is using graph-based approach discussed herein.

The threat intelligence knowledge graph aims to integrate and correlate diverse cybersecurity data sources, providing comprehensive insights into the latest threat landscapes, facilitating threat detection. The rich relations in the knowledge graph can be used to enrich ZIA log data, revealing semantic relations between hostnames that improve kill-chain reconstruction. By enriching ZIA log data with the knowledge graph, the systems can better detect new threats and improve the reconstruction of attack sequences.

For construction of knowledge graphs, the systems treat all unique hostnames present in a log entry as a node. Please note a single hostname might appear in multiple users across organizations but when creating a graph, the systems want to create a single node for the same hostname, reason being we want to propagate the learning from one chain to another.

Various embodiments focus specifically on an ML graph design implementation out of knowledge graphs created using various relations. Knowledge graph enrichment and applying graph ML models on top of it go in parallel. Existing methods process each relationship individually to identify new malicious hostnames. Subsequently, the malicious hostnames identified by each relationship are compiled to form the final results. However, this approach fails to address scenarios where multiple relationships must be analyzed in conjunction to effectively identify parts of a kill-chain. For example, existing methods cannot detect specific hostnames when there is no direct relationship between the seed and that hostname.

When constructing a knowledge graph, the systems apply heuristic values to eliminate noisy edges. Specifically, when utilizing the user Jaccard relation to construct the graph, the systems set a heuristic threshold “t”. The systems then retain only those edges between hostnames where their user Jaccard similarity exceeds this threshold. The existing methods, namely the knowledge graph and random forest methods, each consider only one property-graph relations and node attributes, respectively. By considering both properties jointly, the present systems and methods can achieve enhanced performance.

As stated, cyberattacks often unfold across multiple stages, with each stage involving different network infrastructures and interactions. To reveal the full attacking scenario and effectively prevent such threats, it is crucial to reconstruct the kill-chain, a sequence of events that link malicious activities to their eventual outcomes. The challenge is, given a known malicious hostname, referred to as a seed, to identify other malicious transactions that led to this seed, as well as subsequent malicious events that could follow.

In practical scenarios, the present systems focus on a time window of 10 minutes surrounding the occurrence of a known malicious domain (the seed). Again, this time window can be configured for any amount of time. During this period, all identified malicious URLs are considered part of a kill-chain. This enables the present systems to model the temporal and relational dynamics of a cyberattack.

Two key properties that characterize items within a kill-chain include the following. First, these items are highly correlated with the seed event through multiple relationships, such as redirection paths, download histories, and co-appearance. Second, the hostnames involved tend to display distinctive malicious behaviors, which are essential for classification. Thus, both the intrinsic attributes of a hostname and its relationships to the seed event play pivotal roles in determining whether a hostname belongs to the kill-chain.

To leverage these correlations successfully, the present systems and methods include building a knowledge graph from the log sequences, where each node represents a hostname, and each edge captures a specific type of interaction or relationship between hostnames. The systems then employ a node classification process to label each hostname as malicious or benign. In this context, the types of edges represent diverse correlations between hostnames, and through extensive feature engineering, a plurality of types of such relationships are incorporated into the knowledge graph.

Existing kill-chain reconstruction methods in production employ rule-based, heuristic approaches, where each rule focuses on a single type of correlation between hostnames. Although this method is effective to a certain extent, it suffers from limited generalizability, achieving a recall of 54% and a precision of 77%.

Alternatively, the present systems and methods for kill-chain reconstruction offer three significant improvements. First, a meta-path-based node classification process considers multiple correlations simultaneously, allowing it to capture complex and long-range relationships between hostnames. Second, by utilizing more types of correlations, the model constructs a more comprehensive knowledge graph, which expands the set of hostnames considered. These enhancements contribute to a substantial improvement in recall. Third, the process provides a confidence score for each prediction, enabling administrators to prioritize high-confidence results. Therefore, by utilizing the present systems and methods, the systems can maintain a good level of accuracy, while substantially improving recall. Consequently, the proposed method achieves a precision of 75% and a recall of 70%, marking a significant improvement over existing solutions.

As described, mete-paths are leveraged to determine relationships between hostnames. A mete-path P can be represented as:

P=H₁→{R₁}=→H₂→{R₂}→H₃. . . →{Rₙ}→Hₙ

Hᵢ denotes the node and Rᵢ denotes the edge type between the two nodes. H₁ is the known malicious hostname (i.e., the seed node), and Hᵢ(i≥2) represents context nodes. Each meta-path is associated with a predicted label for the final destination Hₙ and confidence. By default, the systems consider Hₙ is predicted as a malicious hostname.

Some examples of meta-paths that are useful for classifying nodes (hostnames) include the following.

Redirection Meta-path:

seed→{redirect from}→context₁→{redirect from}→context₂

Interpretation: context hostname 2 will be predicted as malicious, as it redirects users to a known malicious hostname.

Post-download Meta-path:

seed→{postdownload}→context₁

Interpretation: context hostname 1 will be predicted as malicious, as the device first downloads a file with suspicious types from the hostname, then the device post information to a known malicious hostname.

Post-download+Redirection Meta-path:

seed→{postdownload}→context₁→{redirect from}→context₂

Interpretation: Find hostnames that have redirected users to the suspicious file download hostname. This example shows that a meta-path can include multiple edge types.

As stated, the process includes knowledge graph construction, building the knowledge graph from transaction logs, where nodes represent hostnames and edges denote interactions such as file downloads or redirects. Further, the process includes meta-path generation exploring the knowledge graph from known malicious hostnames (seed nodes) to generate candidate meta-paths. Finally, the process includes meta-path evaluation and selection where the systems score each meta-path based on its precision and select those that meet a predefined threshold for inference. The models described herein are trained on historical logs, allowing them to identify high-confidence meta-paths that can be applied in the inference stage to predict new malicious nodes.

The following provides a plurality of node features.

URL Features: These features derive from the lexical properties of the URL involved in the transaction. They might include the length of the URL, the use of special characters, and the domain name structure. Edges are added between 2 hostnames if they form the same path and use the same query params as part of their URLs. Intuition behind this relation is that similarly structured hostnames will use similar architecture and framework and might even use the same servers to connect using the same set of path and query parameters. Edge is also added between two hostnames if their URLs are referring to the same file or have very similar patterns.

Request & Response Features: This category includes properties related to the HTTP request and response during the transaction. Examples are HTTP methods, status codes, headers, and the size of data transferred.

User Agent Features: These features pertain to the user agent string provided in the transaction, which can indicate the type of device, operating system, and browser used, potentially flagging anomalous agents that deviate from typical user patterns.

MD5 Features: The MD5 hash of any downloadable content involved in the transaction is used here. This feature can help in identifying malicious payloads by comparing them against known hashes of malware samples.

Policy Features: This includes any transaction policies that were triggered by the event, such as security rules that were enforced or violations that were detected.

Context Features: These are derived by analyzing the broader context of the transaction within the sequence S. Different from the above features that can be directly derived from Lⱼ. This might include the frequency of visits to similar URLs, sequential pattern analysis of user behavior, or any anomalies in transaction timings or volumes.

In addition to node (domain) features, the present knowledge graphs include edge features which make up the various meta-paths. For all the relations the system always starts from the seed and propagates the relation for as many nodes and hops until there is a relationship that is satisfied. The following describes various edge features.

ASN: The models connect two hostnames if they share the same ASN. The intuition behind this relation is that the same threat actor uses similar infrastructure to deploy the malware. At the same time there are some ASNs which are known to host a lot of malicious actors.

Redirection: There are various types of redirection that are considered by the present systems. The system connects two hostnames (domains) if a hostname is referred to by another hostname. The intuition behind this relation is that if a malicious domain is referred by another domain the source domain should also be considered as part of the kill-chain. Further, the system connects two hostnames if a hostname is referred to by another hostname. The difference being that here the system relies on a substring based approach where if a hostname is embedded in the source URL then a chain is formed between source hostname and the current hostname. Additionally, an edge is added between two hostnames if a shortener URL is expanded to a URL of a hostname. Finally, the system visits a URL in VM if it received a 302 response code and checks the destination of the redirection. An edge is added between the two if the URL is redirected to the hostname.

Co-occurrence: an edge is added if two hostnames share the same set of users, quantified by Jaccard similarity. Jaccard similarity is computed using c2.weblog+c2.context to find the Jaccard similarity between two hostnames (Common uuids/(uuids of A+uuids of B)). Once the score is computed the systems use it to apply this score within a time window and add an edge if the Jaccard score between two hostnames is above a threshold. Further, assume a user downloads file F from hostname A. An edge is added between hostname A and hostname B, if file F and hostname B share the same set of users, quantified by Jaccard similarity. Finally, an edge is added if hostname A co-occur with the pattern of the filename downloaded from hostname B.

URL path similarity: An edge is added between two hostnames if they form the same path and use the same query params as part of their URLs. Intuition behind this relation is that similarly structured hostnames will use similar architecture and framework and might even use the same servers to connect using the same set of path and query parameters. Additionally, an edge is added between two hostnames if their URLs are referring to the same file or have very similar patterns.

Shared threat type: Edges are added between two blocked hostnames if they belong to the same threat type. The threat type of a hostname can be inferred by checking the threat name column within the log data.

User agent: an edge is added between two hostnames if they use the same abnormal user agent.

Download: An edge is added between two hostnames if they both have downloading activities within the same time window, respectively. The system checks the presence of certain file names, file types, and URL suffixes that are commonly associated with suspicious file types.

Download-post edge: An edge is added between two hostnames if they have downloading and post activities within the same time window, respectively.

Download-beaconing edge: An edge is added between two hostnames if they have downloading and beaconing activities within the same time window, respectively. The systems can identify beaconing activity using the following method. Let the host path represent the concatenation of the hostname and the URL path. From each URL, the system extracts the host path, and then group the transactions by a combination of attributes: weblog request, host path, weblog user agent, weblog policy, and weblog response. When the count of transactions within a group exceeds a predefined threshold (set to 8 in our production environment), it is inferred that the user exhibits beaconing behavior towards the host via the specified host path.

Same domain edge: An edge is added between two hostnames if they have the same domain.

Threat intelligence edge: An edge is added between a context hostname H (within the same time window of the seed hostname) and the seed hostname S in the following cases. H is used by malware m, that is, context hostname H is linked to malware m. Assume the TLD of H is T, T is rare and is used by malware m, therefore, T is linked to malware m. Assume the URL path of His P, P is rare and is used by malware m, therefore, P is linked to malware m. Assume the file F (filename or MD5) is download from H, F is used by malware m, therefore, F is linked to malware m.

Domain knowledge: Edges are added based on the domain knowledge. For example, based on commonly abused file sharing sites.

Anomaly detection model: Edges are added between seed hostname and the context hostname based on anomaly detection models. The context hostnames are selected from the same time window as the seed hostname. There is no limitation on types and numbers of the anomaly detection models to be employed. At present, the systems utilize a random forest model to fulfill this task.

For training the models for performing the steps described herein, a training phase is contemplated. Given a set of log sequences as training data, where each sequence represents a 10-minute interval of network transaction logs, a model is trained for malicious hostname detection, where the model includes a set of meta-paths. The training begins by constructing a set of knowledge graphs from the log sequences, where each graph is derived from the corresponding log sequence. Each node in the graph represents a hostname, and the edges represent interactions or correlations (e.g., redirection, file downloads, etc.) between hostnames. We proceed iteratively over the set of knowledge graphs. For each graph, we perform a depth-first search (DFS) to explore all possible meta-paths originating from a known malicious node, referred to as the seed node. A meta-path is a sequence of node types and edge types representing a specific type of relationship between the seed node and other hostnames within the knowledge graph. We store the results of this process in a dictionary, where the key is the meta-path, and the value is a list of hostnames predicted as malicious by that particular meta-path.

Each meta-path is evaluated based on the ground-truth malicious hostnames provided. The precision of each meta-path is computed using the labels, which reflects the likelihood that the destination node is malicious. Only meta-paths with a precision above a predefined threshold (for example, 30%) are retained for the inference stage.

For the inference phase, given a 10-minute interval of network transaction logs, we aim to apply learned meta-paths to detect malicious hostnames in sequences. knowledge graphs are constructed for a new log sequence following the same procedure as in the training phase, where nodes represent hostnames and edges represent various types of interactions. For each seed node in the new graph, the systems apply the pre-trained meta-paths to traverse from the seed to candidate target nodes. Each candidate node is classified as malicious if it can be reached via one or more meta-paths and the associated confidence score exceeds a given threshold. All nodes classified as malicious within the same time window are grouped together to form a kill-chain, representing the sequence of events that may indicate a security breach. This helps to reconstruct the timeline and relationships of malicious activities within the network.

For relation-based detection, items in a kill-chain and the initial seed often exhibit shared characteristics, such as similarities in IP address, User Agent, Filename, and the like. Further, attackers frequently misuse redirection techniques to execute cyber-attacks. To address this, the present methods propose constructing a URL/hostname connection graph that leverages the proximity and redirection traits among URLs/hostnames. By initiating from the seed node, the systems employ label propagation to identify elements of the kill-chain.

Given knowledge gained from security researchers, the following rules are enforced by the present systems and methods when predicting kill-chains. Given a log sequence:

$$S = < {L}_{1} , … , {L}_{m} >$$

If URL i∈S is predicted as a kill-chain item, all the URLs in S with the same hostname as i are labeled as kill-chain items. Additionally, given a log sequence as shown above, assume URLs i and j∈S are predicted as a kill-chain items, and i and j have the same hostname. Without loss of generality, the system assumes the request method of i is a connection request, that is ‘connect’, the response size of i is ‘65’, and the User Agent of i contains the keyword ‘Ztunnel’. The URL j is not a connection request. The system can remove URL i from the prediction output. Further, the system will ignore ‘connection’ request if there are no real transactions following up. One exception, if the hostname is TP malicious, then the system keeps it.

Kill-chains which are created by the present systems and methods will have the following schema. The schema of the table is shown below.

| Field | Type | Note |
|---|---|---|
| id | String | Kill-chain id |
| is_seed | Boolean | True if the URL is the seed for the kill-chain |
| | | reconstruction |
| mitre_stage | String | Predicted MITRE stage |
| interpretation_mitre_stage | String | Explain why a specific MITRE stage is predicted |
| importance_flag | Boolean | True if this transaction is not providing redundant |
| | | information False otherwise |
| interpretation_kc_item | String | Reason why this transaction is part of the chain. |
| | | Example - [(refurl - domain name), |
| | | (cooccurrence - domain name - score), rf |
| | | model . . . ] |
| inferred_threat_family | String | threat family inferred. |
| interpretation_threat_family | | Explain why a specific threat family is assigned |
| Weblog fields . . . | . . . | The other weblog fields |

When creating kill-chains, the system might end up creating chains which are 500-600 transactions long because of redundant transactions over the same hostname. We will want to show only important transactions as part of kill-chain events and remove noise. An importance flag will be true if the particular transaction provides new information and is not adding noise.

For MITRE stage inference, the system functions as follows. Given the log sequence including a kill-chain:

$$S = < {L}_{1} , … , {L}_{m} >$$

The system aims to develop a model to predict the MITRE attack stage of each log Lᵢ in the kill-chain S. Specifically, this is a multi-class classification problem. For attribute-based detection, a MITRE annotation model, which takes a log sequence and predicts the MITRE of each item in the sequence, where f (L) is a model, which takes a single URL and predicts the MITRE stage of the URL. This MITRE annotation model can be contemplated as:

$$G ( S ) = \{ f ( {L}_{i} ) \vert {L}_{i} ∈ S \} )$$

It is also assumed that each URL in a kill-chain can only have a single function, and thus a single MITRE stage. There are four MITRE stages the system targets, namely, Resource Development, Initial Access, Command and Control, and Exfiltration. A list of rules can be used to provide default MITRE stages.

For threat family inference, the system includes a model to predict the threat family of the kill-chain. Denoted by:

$$G ( S ) = Agg ( \{ f ( {L}_{i} ) \vert {L}_{i} ∈ S \} )$$

A threat family detection model, which takes a log sequence and predicts the threat family of the sequence, where f (L) is a model, which takes a single log transaction and predicts the threat family of the log transaction. In particular, the system applies f (L) to predict a threat family for each log transaction in S. Finally, aggregation is performed to predicted threat families of all transactions in S and make the final decision. Attribution-based methods will take the internal and external features of a log transaction and predict the threat family of the transaction. Then, majority vote is applied to infer the threat family of the log sequence.

Based on the above-described methods, one or more machine learning models can be trained for performing the kill-chain prediction and reconstruction. That is, based on detecting a malicious domain in user transactions, the present systems can include predicting the kill-chain that led up to that malicious action based on the users transactions from a preconfigured time window prior to the seed transaction.

### Kill-Chain Reconstruction ML Model Evaluation

In various embodiments, the performance of kill-chain reconstruction models is evaluated by precision and recall. The input log sequence of the kill-chain reconstruction model is denoted by:

$$S = 〈 {L}_{1} , … , {L}_{m} 〉$$

The ground-truth kill-chain and ML constructed kill-chain from the input sequence S is denoted by:

$$K = 〈 ( {i}_{1} , {s}_{1} , {q}_{1} ) , … , ( {i}_{n} , {s}_{n} , {q}_{n} ) , M 〉$$

$${K}^{′} = 〈 ( {i}_{1}^{′} , {s}_{1}^{′} , {q}_{1}^{′} ) , … , ( {i}_{m}^{′} , {s}_{m}^{′} , {q}_{m}^{′} ) , M 〉$$

The target URLs that appear in both K and S are denoted by:

I_{K}={iⱼ|iⱼ∈K & iⱼ∈S & iⱼ is not seed}

If S is the augmented weblog, all URLs in K should appear in S.

The URL precision of the model given input S is computed as:

$$P ( S , K ) = \frac{\vert {I}_{K} ⋂ {I}_{{K}^{′}} \vert}{\vert {I}_{{K}^{′}} \vert}$$

The URL recall of the model given input S is computed as:

$$R ( S , K ) = \frac{\vert {I}_{K} ⋂ {I}_{{K}^{′}} \vert}{\vert {I}_{K} \vert}$$

Given a list of test log sequences Ω={S₁, . . . , Sₒ}, the model's precision and recall are defined as the respective averages of these metrics across all sequences. In particular:

$$P = mean ( \{ P ( {S}_{i} , {K}_{i} ) \vert {S}_{i} ∈ Ω \} )$$

$$R = mean ( \{ R ( {S}_{i} , {K}_{i} ) \vert {S}_{i} ∈ Ω \} )$$

To obtain a detailed understanding of the model's precision and recall distribution on the test dataset, we additionally produce histograms depicting these metrics across the log sequences. The x-axis represents bins for precision/recall (10%, 20%, . . . , 100%), while the y-axis indicates the proportion of sequences within each bin.

The inputs to this calculation includes a list of log sequences:

$$Ω = \{ {S}_{1} , … , {S}_{o} \}$$

The corresponding ground-truth kill-chains constructed by a security team:

{K₁, . . . , Kₒ}

And the corresponding ML constructed kill-chains:

{K′₁, . . . , K′ₒ}

Based thereon, the average precision and recall and associated histogram of precision and recall can be produced.

Following similar methods, the systems can compute the precision and recall metrics on a hostname level. That is, the target hostnames that appear in both K and S can be denoted by:

$${H}_{K} = \{ host ( {i}_{j} ) \vert {i}_{j} ∈ K \& {i}_{j} ∈ S \& host ( {i}_{j} ) \neq host ( {i}_{seed} ) \}$$

The hostname precision of the model given input S is computed as:

$$P ( S , K ) = \frac{\vert {I}_{K} ⋂ {I}_{{K}^{′}} \vert}{\vert {I}_{{K}^{′}} \vert}$$

The hostname recall of the model given input S is computed as:

$$R ( S , K ) = \frac{\vert {H}_{K} ⋂ {H}_{{K}^{′}} \vert}{\vert {H}_{K} \vert}$$

Even further, the performance of kill-chain reconstruction in labeling MITRE stages can be computed. The target URLs that appear in both K and S and have the MITRE stage s are denoted by:

$${I}_{K , s} = \{ {i}_{j} \vert {i}_{j} ∈ K \& {i}_{j} ∈ S \& {i}_{j} is not seed \& {s}_{j} = s \}$$

If S is the augmented weblog, all URLs in K should appear in S. Similarly, we have:

$${I}_{{K}^{′} , s} = \{ {i}_{j} \vert {i}_{j} ∈ {K}^{′} \& {i}_{j} ∈ S \& {i}_{j} is not seed \& {s}_{j} = s \}$$

The precision of the model given input S is computed as:

$$P ( S , K , s ) = \frac{\vert {I}_{K , s} ⋂ {I}_{{K}^{′} , s} \vert}{\vert {I}_{{K}^{′} , s} \vert}$$

The recall of the model given input S is computed as:

$$R ( S , K , s ) = \frac{\vert {I}_{K , s} ⋂ {I}_{{K}^{′} , s} \vert}{\vert {I}_{{K}^{′} , s} \vert}$$

Various assumptions pertaining to the present systems and methods for reconstructing/predicting kill-chains include the assumption that all the events pertaining to one kill-chain will happen within a 10 minutes time window. This assumption is derived from empirical data from analysis of over 30,000 kill-chains by security researchers over a span of 18 months. Most often the whole chain of events was identified within this 10 minute window, and diminishing returns are witnessed when increasing the size of the time window vs the effort needed to analyze the same. A second assumption includes the assumption that the likelihood of two kill-chains simultaneously existing within a 10-minute window in the log sequence is minimal. Under this assumption, the focus shifts to determining if a transaction is malicious based solely on its properties. Any transaction identified as malicious is then classified as part of a kill-chain. Finally, another assumption includes that items in a kill-chain and the initial seed often exhibit shared characteristics, such as similarities in IP address, User Agent, Filename, and the like. To address this, the present systems and methods include constructing a URL/hostname connection graph that leverages the proximity and redirection traits among URLs/hostnames. By initiating from the seed node, we employ label propagation to identify elements of the kill-chain.

### Process for Kill-Chain Prediction

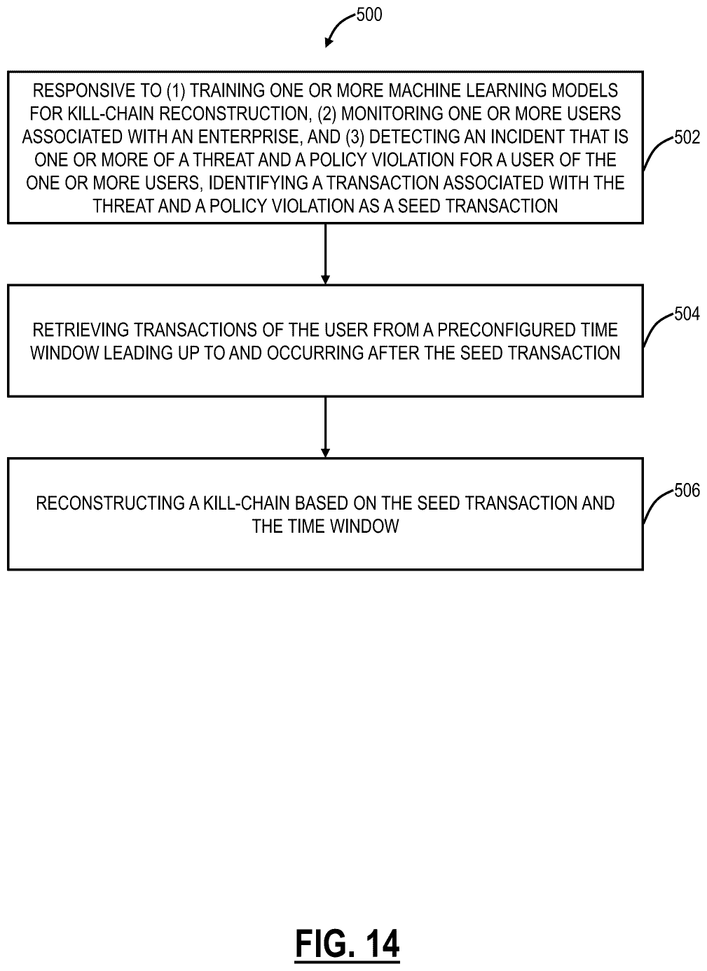

FIG. 14 is a flowchart of a kill-chain reconstruction process 500 utilizing the cloud-based system 120 and associated data. The process 500 can be a computer-implemented method having steps, implemented via one or more servers having processors configured to implement the steps, via the cloud-based system 120, and as instructions embodied in a non-transitory computer-readable medium for causing one or processors to implement the steps.

The kill-chain reconstruction process 500 includes responsive to (1) training one or more machine learning models for kill-chain reconstruction, (2) monitoring one or more users associated with an enterprise, and (3) detecting an incident that is one or more of a threat and a policy violation for a user of the one or more users, identifying a transaction associated with the threat and a policy violation as a seed transaction (step 502); retrieving transactions of the user from a preconfigured time window leading up to and occurring after the seed transaction (step 504); and reconstructing a kill-chain based on the seed transaction and the time window (step 506).

The process 500 can further include wherein the reconstruction is performed by the one or more machine learning models. The kill-chain can include one or more malicious events which might follow the seed transaction. The kill-chain can include one or more transactions that occurred within the time window that are correlated to the seed transaction. A transaction can be correlated to the seed transaction based on a particular website associated with the transaction statistically occurring together with a domain associated with the seed transaction. A transaction can be correlated to the seed transaction based on one or more features of the transaction. The one or more features of the transaction can include any of Uniform Resource Locator (URL) features, Request & Response (R&R) features, User Agent (UA) features, Message Digest 5 (MD5) features, policy features, and context features. The reconstructing can be performed using a graph-based approach. Each transaction in the kill-chain can be assigned a corresponding MITRE attack stage. The transactions of the user from the preconfigured time window can be obtained from a cloud-based system that performs monitoring of the one or more users.

### Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### CONCLUSION

As used herein, including in the claims, the phrases “at least one of” or “one or more of” a list of items refer to any combination of those items, including single members. For example, “at least one of: A, B, or C” covers the possibilities of: A only, B only, C only, a combination of A and B, a combination of A and C, a combination of B and C, and a combination of A, B, and C. Additionally, the terms “comprise,” “comprises,” “comprising,” “include,” “includes,” and “including” are intended to be non-limiting and open-ended. These terms specify essential elements or steps but do not exclude additional elements or steps, even when a claim or series of claims includes more than one of these terms.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

Although operations, steps, instructions, and the like are shown in the drawings in a particular order, this does not imply that they must be performed in that specific sequence or that all depicted operations are necessary to achieve desirable results. The drawings may schematically represent example processes as flowcharts or flow diagrams, but additional operations not depicted can be incorporated. For instance, extra operations can occur before, after, simultaneously with, or between any of the illustrated steps. In some cases, multitasking and parallel processing are contemplated. Furthermore, the separation of system components described should not be interpreted as mandatory for all implementations, as the program components and systems can be integrated into a single software product or distributed across multiple software products.

What is claimed is:

1. A non-transitory computer-readable storage medium having computer-readable code stored thereon for programming one or more processors to perform steps of:
responsive to (1) training one or more machine learning models for kill-chain reconstruction, (2) monitoring one or more users associated with an enterprise, and (3) detecting an incident that is one or more of a threat and a policy violation for a user of the one or more users, identifying a transaction associated with the threat and a policy violation as a seed transaction;
retrieving transactions of the user from a preconfigured time window leading up to and occurring after the seed transaction; and
reconstructing a kill-chain based on the seed transaction and the time window.

2. The non-transitory computer-readable storage medium of claim 1, wherein the reconstruction is performed by the one or more machine learning models.

3. The non-transitory computer-readable storage medium of claim 1, wherein the kill-chain comprises one or more malicious events which might follow the seed transaction.

4. The non-transitory computer-readable storage medium of claim 1, wherein the kill-chain comprises one or more transactions that occurred within the time window that are correlated to the seed transaction.

5. The non-transitory computer-readable storage medium of claim 4, wherein a transaction is correlated to the seed transaction based on a particular website associated with the transaction statistically occurring together with a domain associated with the seed transaction.

6. The non-transitory computer-readable storage medium of claim 4, wherein a transaction is correlated to the seed transaction based on one or more features of the transaction.

7. The non-transitory computer-readable storage medium of claim 6, wherein the one or more features of the transaction comprise any of Uniform Resource Locator (URL) features, Request & Response (R&R) features, User Agent (UA) features, Message Digest 5 (MD5) features, policy features, and context features.

8. The non-transitory computer-readable storage medium of claim 1, wherein the reconstructing is performed using a graph-based approach.

9. The non-transitory computer-readable storage medium of claim 1, wherein each transaction in the kill-chain is assigned a corresponding MITRE attack stage.

10. The non-transitory computer-readable storage medium of claim 1, wherein the transactions of the user from the preconfigured time window are obtained from a cloud-based system that performs monitoring of the one or more users.

11. A method comprising steps of:
responsive to (1) training one or more machine learning models for kill-chain reconstruction, (2) monitoring one or more users associated with an enterprise, and (3) detecting an incident that is one or more of a threat and a policy violation for a user of the one or more users, identifying a transaction associated with the threat and a policy violation as a seed transaction;
retrieving transactions of the user from a preconfigured time window leading up to and occurring after the seed transaction; and
reconstructing a kill-chain based on the seed transaction and the time window.

12. The method of claim 11, wherein the reconstruction is performed by the one or more machine learning models.

13. The method of claim 11, wherein the kill-chain comprises one or more malicious events which might follow the seed transaction.

14. The method of claim 11, wherein the kill-chain comprises one or more transactions that occurred within the time window that are correlated to the seed transaction.

15. The method of claim 14, wherein a transaction is correlated to the seed transaction based on a particular website associated with the transaction statistically occurring together with a domain associated with the seed transaction.

16. The method of claim 14, wherein a transaction is correlated to the seed transaction based on one or more features of the transaction.

17. The method of claim 16, wherein the one or more features of the transaction comprise any of Uniform Resource Locator (URL) features, Request & Response (R&R) features, User Agent (UA) features, Message Digest 5 (MD5) features, policy features, and context features.

18. The method of claim 11, wherein the reconstructing is performed using a graph-based approach.

19. The method of claim 11, wherein each transaction in the kill-chain is assigned a corresponding MITRE attack stage.

20. The method of claim 11, wherein the transactions of the user from the preconfigured time window are obtained from a cloud-based system that performs monitoring of the one or more users.
